(19) United States
(12) Patent Application Publication
(10) Pub. No.: US 2026/0279095 A1
(43) Pub. Date: Sep. 17, 2026

(54) ELECTRONIC APPARATUS

(71) Applicant: CANON KABUSHIKI KAISHA, Tokyo (JP)

(72) Inventor: YOHEI YAMADA, Tokyo (JP)

(21) Appl. No.: 19/556,902

(22) Filed: Mar. 4, 2026

(30) Foreign Application Priority Data
Mar. 11, 2025 (JP) 2025-038546

(51) Int. Cl. G06V 40/13; H04N 23/50

(52) U.S. Cl. CPC G06V 40/1306; H04N 23/50

(57) ABSTRACT

An electronic apparatus includes a grip portion to be gripped by a hand of a user, a convex shape portion that is formed above the grip portion and protrudes outward from the grip portion to support holding weight of the electronic apparatus with a hand, and a fingerprint detection device disposed at a position touched by a fingertip beyond a first joint of a finger in a case where the user grips the grip portion with the finger of the hand along the convex shape portion, the fingerprint detection device having a fingerprint reading range in a longitudinal direction of the finger wider than a fingerprint reading range in a width direction of the finger.

### CROSS REFERENCE TO RELATED APPLICATION

This application claims the benefit of Japanese Patent Application No. 2025-038546, filed Mar. 11, 2025, which is hereby incorporated by reference herein in its entirety.

### BACKGROUND

### Field of the Technology

The present disclosure relates to an electronic apparatus having a fingerprint authentication function.

### Description of the Related Art

There is a known electronic apparatus, such as an image capturing apparatus, having a fingerprint authentication function of reading a fingerprint of a user, collating it with previously registered fingerprint information, and performing control according to a collation result.

For example, Japanese Patent Laid-Open No. 2020-136977 discloses the following image capturing apparatus. That is, a manipulation unit is provided with a fingerprint information recognition sensor unit, fingerprint information of a shooter's finger is stored, and a face image of the shooter obtained from an image capturing unit and the fingerprint information of the shooter are stored in association with each other. Further, the image capturing apparatus has a self-portrait function that tracks the shooter so as to ensure the shooter is within the shooting field angle at the time of shooting.

Japanese Patent Laid-Open No. 2006-165987 discloses an electronic camera in which a specific part (a position touched by a fingertip) of a front face of the camera is provided with a fingerprint reading means, and an operation of the camera is controlled based on a control condition associated with information of an owner of the fingerprint.

However, in the known technique disclosed in Japanese Patent Laid-Open No. 2020-136977, the fingerprint authentication function operates only when the manipulation unit is manipulated, and it is necessary to break shooting posture in order to manipulate the manipulation unit, which may impact shooting opportunity.

In the known technique disclosed in Japanese Patent Laid-Open No. 2006-165987, since only the specific part is provided with the fingerprint reading means, the position thereof does not align with the fingertip depending on the size of the hand and the way of holding, which may decrease the fingerprint detection accuracy.

### SUMMARY

The present disclosure has been made in view of the above-described problems, and provides an electronic apparatus that can improve operability and accuracy of a fingerprint authentication operation.

According to an aspect of the present disclosure, there is provided an electronic apparatus comprising: a grip portion to be gripped by a hand of a user; a convex shape portion that is formed above the grip portion and protrudes outward from the grip portion to support holding weight of the electronic apparatus with a hand; and a fingerprint detection device disposed at a position touched by a fingertip beyond a first joint of a finger in a case where the user grips the grip portion with the finger of the hand along the convex shape portion, the fingerprint detection device having a fingerprint reading range in a longitudinal direction of the finger wider than a fingerprint reading range in a width direction of the finger.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram of a digital camera that is a first embodiment of an electronic apparatus of the present disclosure;

FIGS. 2A and 2B are external perspective views of the digital camera of the first embodiment;

FIG. 3 is an exploded perspective view of the digital camera of the first embodiment;

FIGS. 4A and 4B are detailed views of a front fingerprint detection unit of the first embodiment;

FIGS. 5A and 5B are relationship views between the front fingerprint detection unit and a front grip guide shape of the first embodiment;

FIGS. 6A and 6B are views illustrating shooting posture of a general camera;

FIGS. 7A and 7B are detailed views illustrating a modification of a peripheral shape of the front fingerprint detection unit of the first embodiment;

FIGS. 8A and 8B are rear views of the digital camera of the first embodiment;

FIG. 9 is a flowchart of a grip detection operation in the first embodiment;

FIG. 10 is an external perspective view of a digital camera of a second embodiment;

FIG. 11 is an external perspective view of a digital camera of a third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

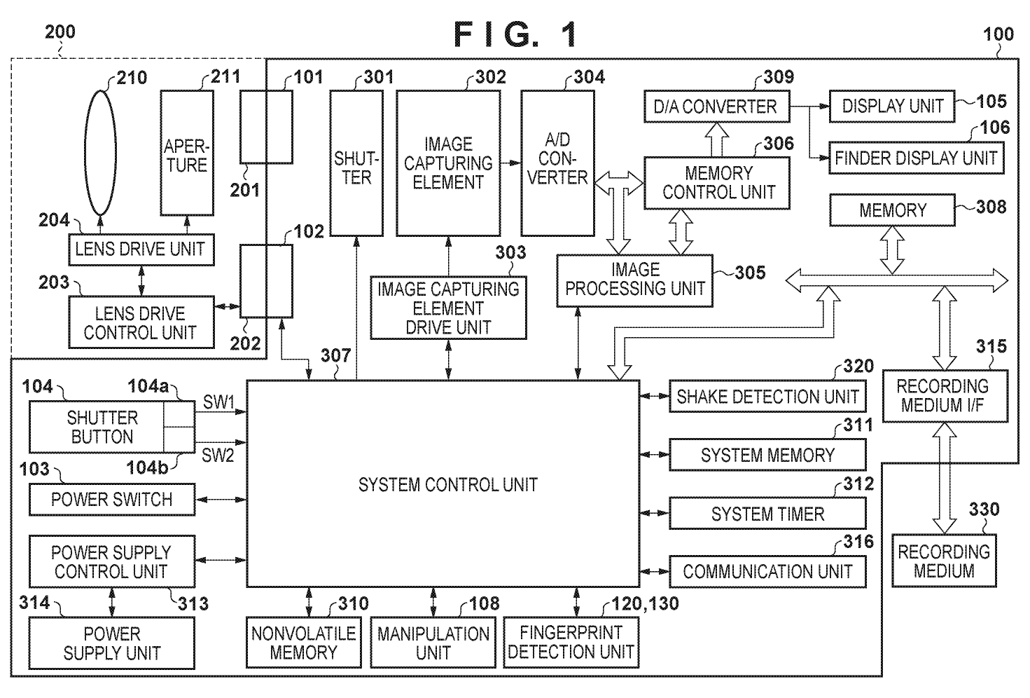

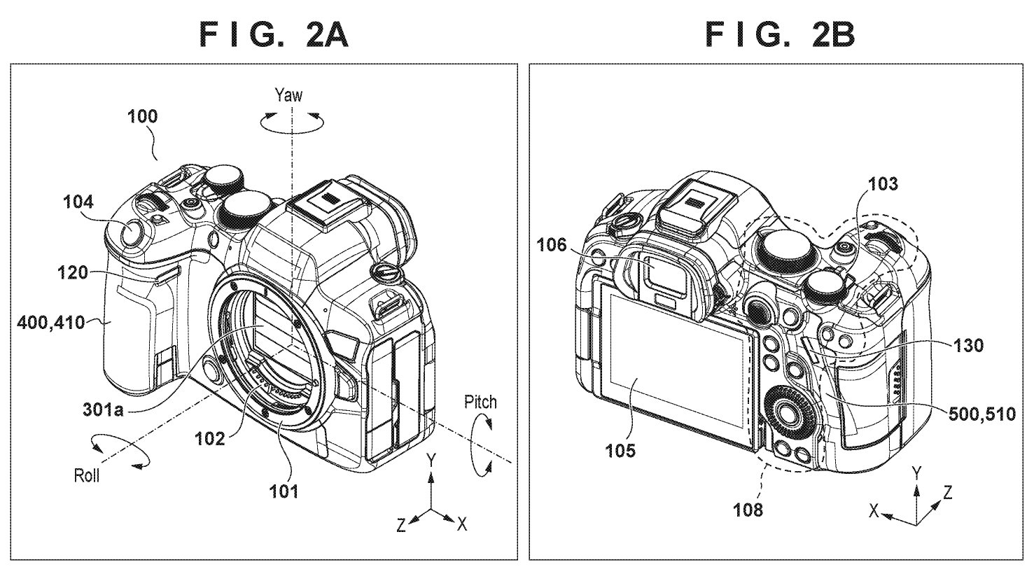

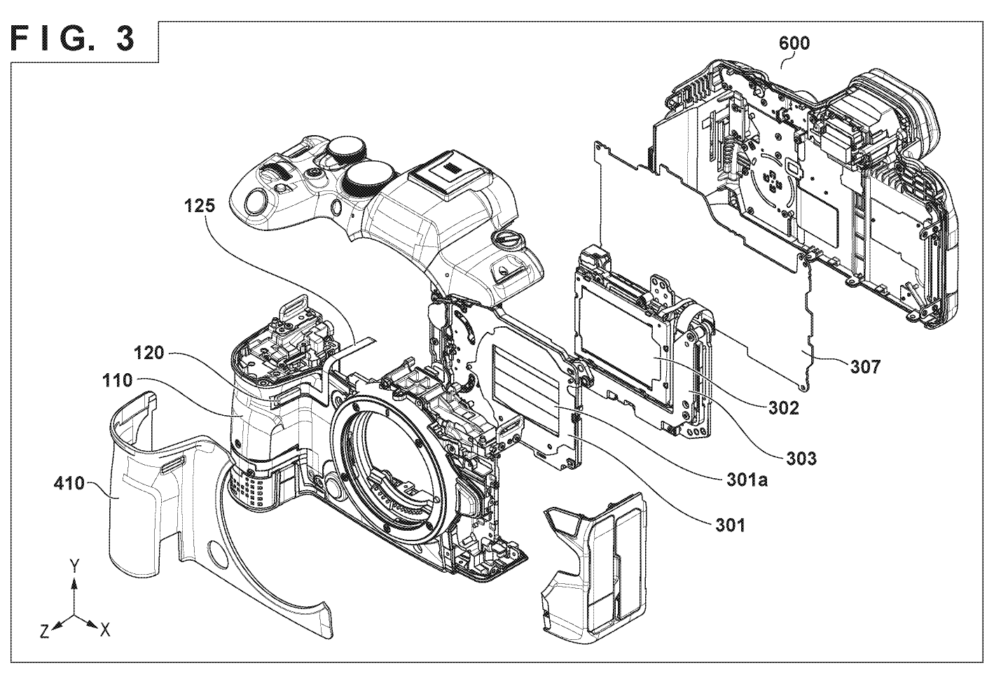

FIG. 1 is a block diagram of a digital camera 100 as an image capturing apparatus that is an example of an electronic apparatus in the first embodiment to which the present disclosure is applied. FIGS. 2A and 2B are external perspective views of the digital camera 100. FIGS. 2A and 2B are views of the digital camera 100 as viewed from a front side and a back side, respectively. FIG. 3 is an exploded perspective view of the digital camera 100 of the present embodiment.

The digital camera 100 is an interchangeable-lens camera to which a lens unit 200 is attachable and detachable. The lens unit 200 is fixed to the digital camera 100 by a lens mount 201 provided in the lens unit 200 and a lens mount 101 provided in the digital camera 100. The lens unit 200 and the digital camera 100 are configured to be able to communicate with each other via a lens side connector 202 provided in the lens unit 200 and a camera side connector 102 provided in the digital camera 100. Specifically, a system control unit 307 and a lens drive control unit 203 communicate with each other, the lens drive control unit 203 controls a lens drive unit 204 based on a signal from the system control unit 307, and the lens drive unit 204 drives an aperture 211 and a lens 210. The lens 210 forms an image of light from a subject on an image capturing element 302.

A shutter 301 is formed of a focal plane shutter, is disposed between the image capturing element 302 and the lens 210, and shields light that would enter from the lens 210 into the image capturing element 302 in a non-shooting state. At the time of shooting and through image display (live view display), a shutter blade 301a is opened under the control of the system control unit 307 to allow light from the lens 210 to be guided to the image capturing element 302. The image capturing element 302 is constituted by a CCD, a CMOS element, or the like that converts an optical image into an electric signal, and has an electronic shutter function.

An A/D converter 304 converts an analog signal output from the image capturing element 302 into a digital signal.

An image processing unit 305 performs resizing processing such as predetermined pixel interpolation and reduction, and color conversion processing on data from the A/D converter 304 or data from a memory control unit 306. The image processing unit 305 performs predetermined calculation processing using captured image data, and the system control unit 307 performs exposure control and focus detection control based on the obtained calculation result. By this, autofocus (AF) processing, auto exposure (AE) processing, flash preliminary light emission (EF) processing, and auto white balance (AWB) processing that are of a through the lens (TTL) method are performed.

Output data from the A/D converter 304 is directly written into a memory 308 via the image processing unit 305 and the memory control unit 306 or via the memory control unit 306. The memory 308 stores image data converted into digital data by the A/D converter 304. The memory 308 also serves as an image display memory (video memory). A D/A converter 309 converts image display data stored in the memory 308 into an analog signal to supply it to a display unit 105 or a finder display unit 106. In this manner, the display image data written in the memory 308 is displayed by the display unit 105 or the finder display unit 106 via the D/A converter 309. The display unit 105 and the finder display unit 106 perform display according to the analog signal from the D/A converter 309 on a display such as an LCD. The display unit 105 incorporates a capacitance type or a pressure sensitive type touch panel, and has a touch panel function that enables the user to perform various manipulations by touching with a finger or the like. A digital signal having been once A/D converted by the A/D converter 304 and accumulated in the memory 308 is analog-converted by the D/A converter 309, sequentially transferred to the display unit 105 or the finder display unit 106, and displayed, whereby through image display can be performed.

A nonvolatile memory 310 is an electrically erasable/recordable recording medium, and for example, an EEPROM or the like is used. The nonvolatile memory 310 stores operational constants, programs, and the like of the system control unit 307.

The system control unit 307 is a control unit including at least one processor, and controls the entire digital camera 100 and the lens unit 200. A RAM is used as a system memory 311. Operational constants and variables of the system control unit 307, programs read from the nonvolatile memory 310, and the like are deployed in the system memory 311. The system control unit 307 also performs display control by controlling the memory 308, the D/A converter 309, the display unit 105, the finder display unit 106, and the like.

A system timer 312 measures time used for various types of control and time of a built-in clock.

A first shutter switch 104a is turned on during the manipulation on a shutter button 104 provided in the digital camera 100, that is, by what is called a half‑press (shooting preparation instruction), and generates a first shutter switch signal SW1. By the first shutter switch signal SW1, operations such as AF processing, AE processing, AWB processing, and EF processing are started.

A second shutter switch 104b is turned on upon completion of manipulation on the shutter button 104, that is, by what is called a full-press (shooting instruction), and generates a second shutter switch signal SW2. The system control unit 307 controls so as to drive the shutter blade 301a by the second shutter switch signal SW2, and starts a series of shooting processing operations from reading of a signal from the image capturing element 302 to writing of image data into a recording medium 330. The shutter blade 301a travels at high speed in a direction perpendicular to an optical axis of lens 210 inside the shutter 301, and stops its operation by colliding with a stopper member (not illustrated) inside the shutter 301.

Each manipulation member of the manipulation unit 108 is appropriately assigned a function for each scene by selecting and manipulating various function icons displayed on the display unit 105 or the finder display unit 106, and functions as various function buttons. Examples of the function buttons include an end button, a return button, an image feed button, a jump button, a narrowing button, and an attribute change button. For example, when a menu button is pressed, various settable menu screens are displayed on the display unit 105 or the finder display unit 106.

The power supply of the digital camera 100 is configured to be switchable between on and off by a manipulation on a power switch 103. A power supply control unit 313 is constituted by a battery detection circuit, a DC-DC converter, a switch circuit that switches a block to be energized, and the like, and detects whether a battery is attached, a type, and a remaining amount. The power supply control unit 313 controls the DC-DC converter based on the detection result and an instruction of the system control unit 307, and supplies a necessary voltage to each unit including the recording medium 330 for a necessary period.

A power supply unit 314 includes a primary battery such as an alkaline battery or a lithium battery, a secondary battery such as a NiCd battery, a NiMH battery, or a Li ion battery, an AC adapter, or the like. A recording medium I/F 315 is an interface with the recording medium 330 such as a memory card or a hard disk. The recording medium 330 is a recording medium such as a memory card for recording a shot image, and is constituted by a semiconductor memory, an optical disk, a magnetic disk, or the like.

A communication unit 316 is connected to an external apparatus wirelessly or by a wired cable, and performs transmission/reception of a video signal, an audio signal, and the like. The communication unit 316 can also be connected to a wireless local area network (LAN) or the Internet. The communication unit 316 can transmit an image (including a through image) captured by the image capturing element 302 and an image recorded on the recording medium 330, and can receive image data and other various types of information from an external apparatus.

A shake detection unit 320 is constituted by, for example, a gyro sensor or the like, and detects a vibration amount of the digital camera 100. The shake detection unit 320 detects vibration and the vibration amount in three axial directions of a pitch direction, a yaw direction, and a roll direction in the digital camera 100.

An image capturing element drive unit 303 performs optical shake correction by controlling movement of the image capturing element 302 according to the shake amount detected by the shake detection unit 320. The image processing unit 305 electronically corrects the shake of the image according to the shake amount detected by the shake detection unit 320 under the control of the system control unit 307.

The digital camera 100 includes a front grip 400 (front grip portion) and a rear grip 500 (rear grip portion) for the user to hold the digital camera 100. The front grip 400 and the rear grip 500 are constituted by a front grip rubber 410 and a rear grip rubber 510, respectively, which are formed of a material having flexibility on the surfaces, such as synthetic rubber or elastomer. The front grip 400 is formed in a curved surface shape protruding to the front face that allows the user to engage and hook mainly a middle finger, a ring finger, and a little finger. The front grip 400 is not formed in a curved surface shape having a uniform curvature, but is formed in a three-dimensional curved surface with a partially provided unevenness. The rear grip 500 is distinguished from the periphery by providing a step or the like, and is formed of a three-dimensional curved surface for the user to place the palm mainly from a thumb. This allows the user to hold the digital camera 100 by gripping the front grip 400 and the rear grip 500.

A base plate 110 is a structural body responsible for the strength of the digital camera 100, and a rear cover unit 600, the shutter 301, the image capturing element 302, the image capturing element drive unit 303, and the system control unit 307 are fastened by screws (not illustrated).

A front fingerprint detection unit 120 and a rear fingerprint detection unit 130 are electric elements constituted by a fingerprint detection sensor that can acquire fingerprint images. As illustrated in FIG. 3, the front fingerprint detection unit 120 and the rear fingerprint detection unit 130 are electrically connected to the system control unit 307 via a front communication circuit board 125 and a rear communication circuit board (not illustrated) made of flexible printed circuits having flexibility. The fingerprint images acquired by the front fingerprint detection unit 120 and the rear fingerprint detection unit 130 when touched by the finger of the user are transmitted to the system control unit 307 as electric signals. Then, the system control unit 307 determines whether the acquired fingerprint image matches the fingerprint information registered in advance in the digital camera 100. By this, what is called a fingerprint authentication function that can identify an individual is configured. Here, since the detailed configuration of the fingerprint sensor, and the fingerprint information registration method and authentication method are known techniques, detailed description thereof will be omitted.

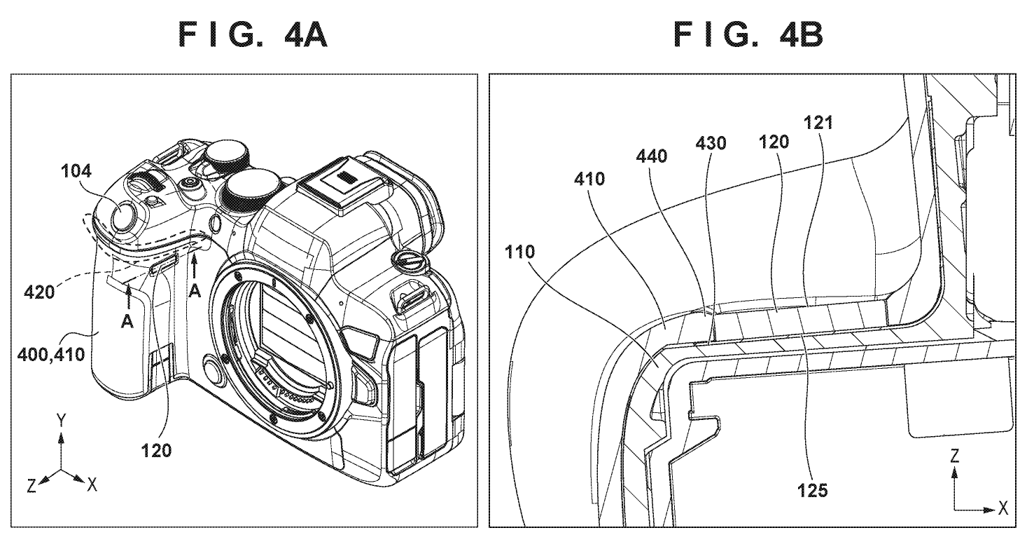

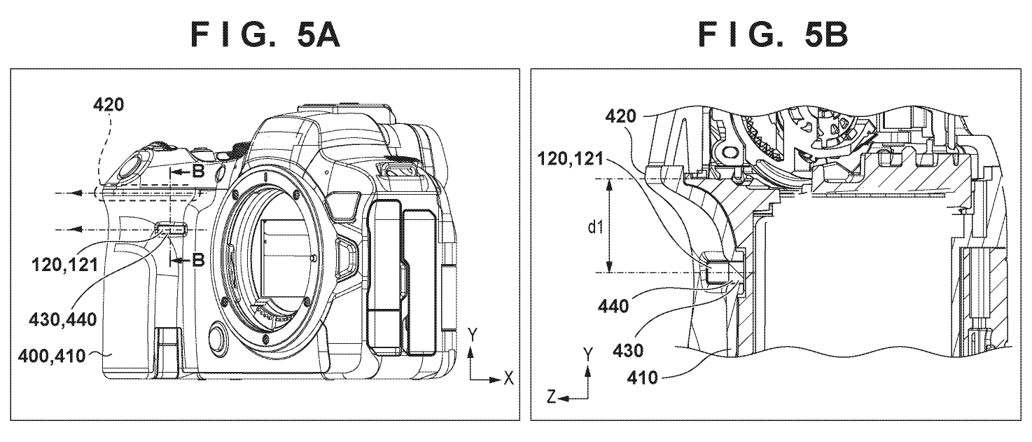

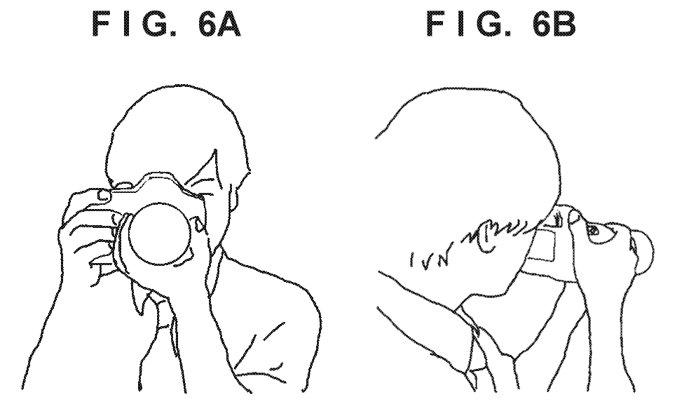

FIGS. 4A and 4B are detailed views of the front fingerprint detection unit 120 of the digital camera 100. FIG. 4A is an external perspective view of the digital camera 100 illustrating the disposition of the front fingerprint detection unit 120. FIG. 4B is an enlarged cross-sectional view taken along line A-A in FIG. 4A. FIGS. 5A and 5B are relationship views between the front fingerprint detection unit 120 and a front grip guide shape 420 of the digital camera 100. FIG. 5A is a view of the digital camera 100 as viewed from a viewpoint rotated about a Y axis. FIG. 5B is an enlarged cross-sectional view taken along line B-B in FIG. 5A. FIGS. 6A and 6B are views illustrating shooting posture of a general camera. FIGS. 6A and 6B are views of the digital camera 100 as viewed from a front side and a back side, respectively.

The front grip guide shape 420 is provided below the shutter button 104 of the front grip 400 (broken line portion in the drawing), and is formed in an eaves shape (convex shape) in which the front grip rubber 410 protrudes outward with respect to the curved surface shape of the front grip 400. This allows the user to grip the digital camera 100 by engaging the middle finger with the front grip 400 along the front grip guide shape 420 when gripping it as illustrated in FIGS. 6A and 6B. At this time, since the user can grip the digital camera 100 such that the middle finger is hooked by the front grip guide shape 420, the user can stably grip the digital camera. Note that the front grip guide shape is disposed for the purpose of supporting the weight of the digital camera 100 with fingers, and thus is disposed above the front grip 400 in the gravity direction.

As illustrated in FIGS. 5A and 5B, the front fingerprint detection unit 120 is disposed at a substantially parallel position separated from the front grip guide shape 420 by a predetermined distance (d1 in the drawing). The front fingerprint detection unit 120 includes a front fingerprint contact portion 121 on an appearance surface, and is configured to be able to read the fingerprint when the finger of the user comes into contact with the surface of the front fingerprint contact portion 121. The front fingerprint detection unit 120 is surface-mounted on the front communication circuit board 125 by soldering, and the front communication circuit board 125 is attached and fixed to the base plate 110 by a double-sided tape (not illustrated).

Here, it is desirable to dispose the front fingerprint contact portion 121 so as to be positioned in a range touched by the fingertip beyond the first joint of the middle finger of the user when the user grips the digital camera 100.

Specifically, in order to determine the range touched by the fingertip beyond the first joint of the middle finger of the user, a plurality of users are asked to grip the digital camera 100 as subjects, and the position of the front fingerprint contact portion 121 is determined from the experiment result. Alternatively, the position of the front fingerprint contact portion 121 may be determined by disposing shapes of hands having various sizes on a design model as electronic data.

When the user grips the digital camera 100, the position of the fingertip beyond the first joint of the middle finger varies depending on the difference in size of the hand of the user, especially difference in finger length. This is because the engagement amount of the middle finger with respect to the front grip 400 varies depending on the difference in finger length. In the present embodiment, an electric element having a rectangular outer shape is adopted as the front fingerprint contact portion 121. Specifically, a direction parallel to the front grip guide shape 420 is defined as a long side, and a direction orthogonal thereto is defined as a short side.

In other words, the front fingerprint contact portion 121 (the front fingerprint detection unit 120) has a shape that is disposed at a position touched by the fingertip beyond the first joint of the middle finger and has a dimension corresponding to the longitudinal direction of the middle finger set to be longer than the dimension corresponding to the width direction of the middle finger in a case where the user grips the front grip 400 with the middle finger of the hand along the front grip guide shape (convex shape portion) 420. This dimension corresponding to the longitudinal direction of the middle finger is, for example, a dimension larger than the width of the middle finger. This is because even in a case where the position of the fingertip beyond the first joint of the middle finger varies depending on the difference in length of the finger of the user, the difference in position can be covered by the size of the front fingerprint contact portion 121.

Disposing the front fingerprint contact portion 121 as described above allows the user to touch the front fingerprint contact portion 121 in a gripped state even if the position of the fingertip beyond the first joint of the middle finger varies depending on the difference in finger length, when the user grips the digital camera 100. Therefore, the fingerprint detection accuracy is high. That is, the fingerprint authentication operation can be performed with high detection accuracy without breaking the shooting posture.

As illustrated in FIG. 4B, the front grip rubber 410 is provided with a front grip opening portion 430, which is partially opened so that the front fingerprint detection unit 120 is inserted, with a slight gap with respect to the outer shape of the front fingerprint detection unit 120 at a position corresponding to the front fingerprint detection unit 120.

Here, it is desirable that the front fingerprint contact portion 121 and the front grip rubber 410 peripheral thereto have the same surface. Specifically, the periphery of the front grip opening portion 430 is formed into a surface shape having the same height as the front fingerprint contact portion 121. In the present embodiment, as described above, the front grip 400 is not formed in a curved surface shape having a uniform curvature, but is formed in a three-dimensional curved surface with a partially provided unevenness. Therefore, the periphery of the front grip opening portion 430 does not have a plane shape, and is not the same face as the front fingerprint contact portion 121. The periphery of the front grip opening portion 430 is provided with a front grip opening edge portion 440 having an inclination so as to be at the same height as the outer periphery (appearance face) of the front fingerprint contact portion 121. This eliminates a steep step between the periphery of the front grip opening portion 430 and the front fingerprint contact portion 121, and can alleviate deformation of the fingertip when the fingertip touches. That is, since deformation of the fingerprint is alleviated, the fingerprint detection accuracy is good.

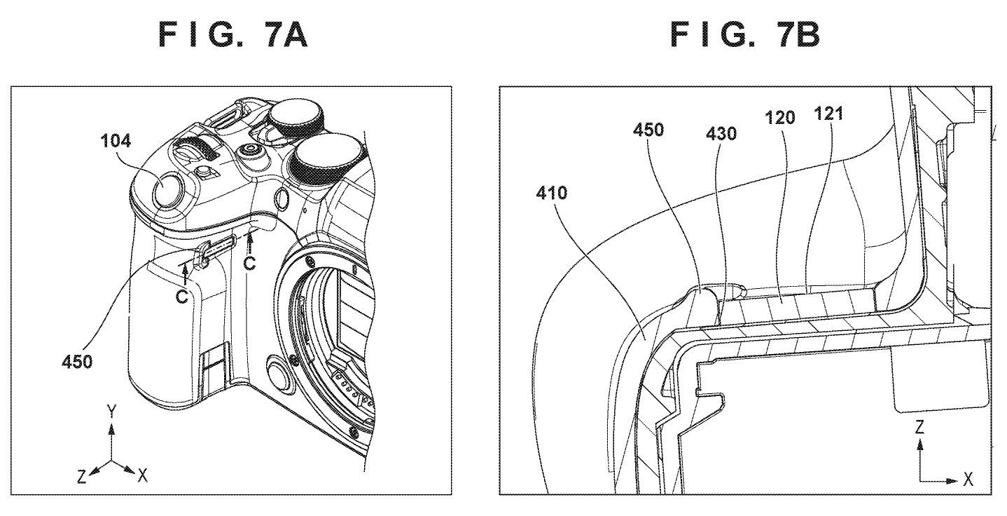

FIG. 7A is a detailed view illustrating a modification of a peripheral shape of the front fingerprint detection unit 120. FIG. 7B is an enlarged cross-sectional view taken along line C-C in FIG. 7A.

The periphery of the front grip opening portion 430 is provided with a front grip opening locking portion 450 having an inclination so as to be at the same height as the outer periphery of the front fingerprint contact portion 121 and formed in a convex shape having a height higher than the surface of the front grip rubber 410. By this, when the user grips the digital camera 100, the fingertip is hooked by the front grip opening locking portion 450, and therefore the digital camera 100 can be held without the fingertip slipping on the surface of the front fingerprint contact portion 121.

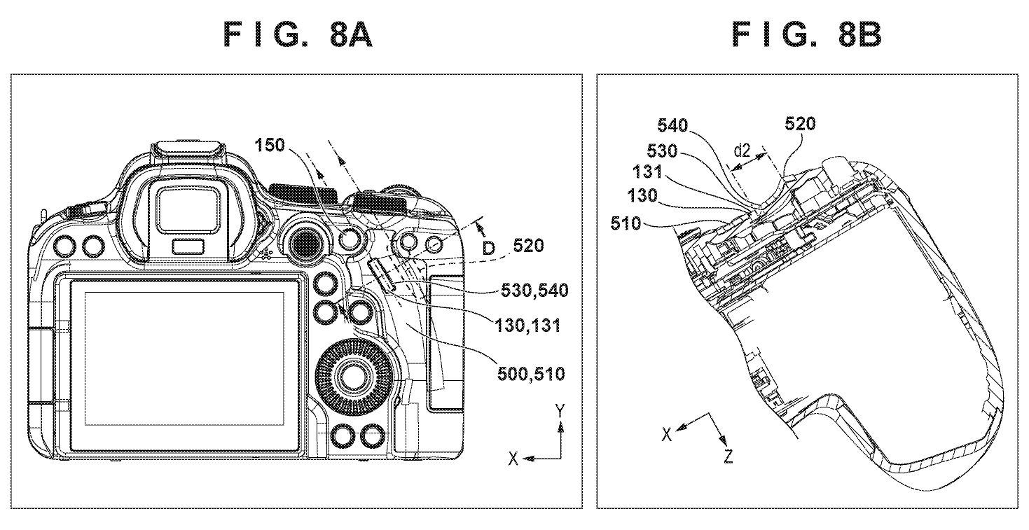

FIG. 8A is a rear view of the digital camera 100. FIG. 8B is an enlarged cross-sectional view taken along line D-D in FIG. 8A.

A rear grip guide shape 520 is provided on an upper right side (broken line portion in the drawing) of the rear grip 500, and is formed in a projection shape in which the rear grip rubber 510 protrudes outward with respect to the curved surface shape peripheral to the rear grip 500. This allows the user to grip the digital camera 100 such that the inner surface of the thumb is hooked by the rear grip guide shape 520, and therefore the user can stably grip the digital camera 100 when gripping it as illustrated in FIGS. 6A and 6B.

The rear fingerprint detection unit 130 is disposed at a substantially parallel position separated from the rear grip guide shape 520 by a predetermined distance (d2 in the drawing). The rear fingerprint detection unit 130 includes a rear fingerprint contact portion 131 on an appearance surface, and is configured to be able to read the fingerprint when the finger of the user comes into contact with the surface of the rear fingerprint contact portion 131. A rear face opening portion 530 and a rear opening edge portion 540 are formed in a periphery of the rear fingerprint detection unit 130 of the rear grip rubber 510. Since the same configuration as that of the front fingerprint detection unit 120 described above can be applied to the detailed configuration and the peripheral configuration of the rear fingerprint detection unit 130, description thereof will be omitted.

Here, it is desirable that the rear fingerprint contact portion 131 is disposed so as to be positioned in a range touched by the fingertip beyond the first joint of the thumb of the user when the user grips the digital camera 100. Specifically, in order to determine the range touched by the fingertip beyond the first joint of the thumb of the user, a plurality of users are asked to grip the digital camera 100 as subjects, and the position of the rear fingerprint contact portion 131 is determined from the experiment result. Alternatively, the position of the rear fingerprint contact portion 131 may be determined by disposing shapes of hands having various sizes on a design model as electronic data. By this, when the user grips the digital camera 100, even if the position of the fingertip beyond the first joint of the thumb varies depending on the difference in finger length, the user can touch the rear fingerprint contact portion 131 in a gripped state, and therefore the fingerprint detection accuracy is good.

In other words, the rear fingerprint contact portion 131 (the rear fingerprint detection unit 130) has a shape that is disposed at a position touched by the fingertip beyond the first joint of the thumb and has a dimension corresponding to the longitudinal direction of the thumb set to be longer than the dimension corresponding to the width direction of the thumb in a case where the user grips the digital camera 100 with the thumb of the hand along the rear grip guide shape (projection shape) 520. This dimension corresponding to the longitudinal direction of the thumb is, for example, a dimension larger than the width of the thumb. This is because even in a case where the position of the fingertip beyond the first joint of the thumb varies depending on the difference in length of the finger of the user, the difference in position can be covered by the size of the rear fingerprint contact portion 131.

Here, a push button 150 is a button for manipulating at the time of shooting. In the present embodiment, the push button 150 is assigned a function for starting a focusing operation. The push button 150 is disposed in the vicinity of the rear grip 500 and at a position where the user can push it with the fingertip of the thumb such that the user can press it in a state of gripping the digital camera 100 at the time of shooting. The push button 150 is disposed in the vicinity of the rear fingerprint detection unit 130 and in the vicinity of an extension line in the longitudinal direction of the rear fingerprint detection unit 130. This allows the user to perform fingerprint detection by the rear fingerprint detection unit 130 and manipulation on the push button 150 in a state of gripping the digital camera 100.

As described above, the front grip 400 and the rear grip 500 are provided with the front grip guide shape 420 and the rear grip guide shape 520, respectively. This enables the digital camera 100 to be stably gripped. The front fingerprint detection unit 120 and the rear fingerprint detection unit 130 are disposed at substantially parallel positions separated by a predetermined distance from the front grip guide shape 420 and the rear grip guide shape 520, respectively. This allows the user to detect the fingerprint with the front fingerprint detection unit 120 and the rear fingerprint detection unit 130 in a state of gripping the digital camera 100.

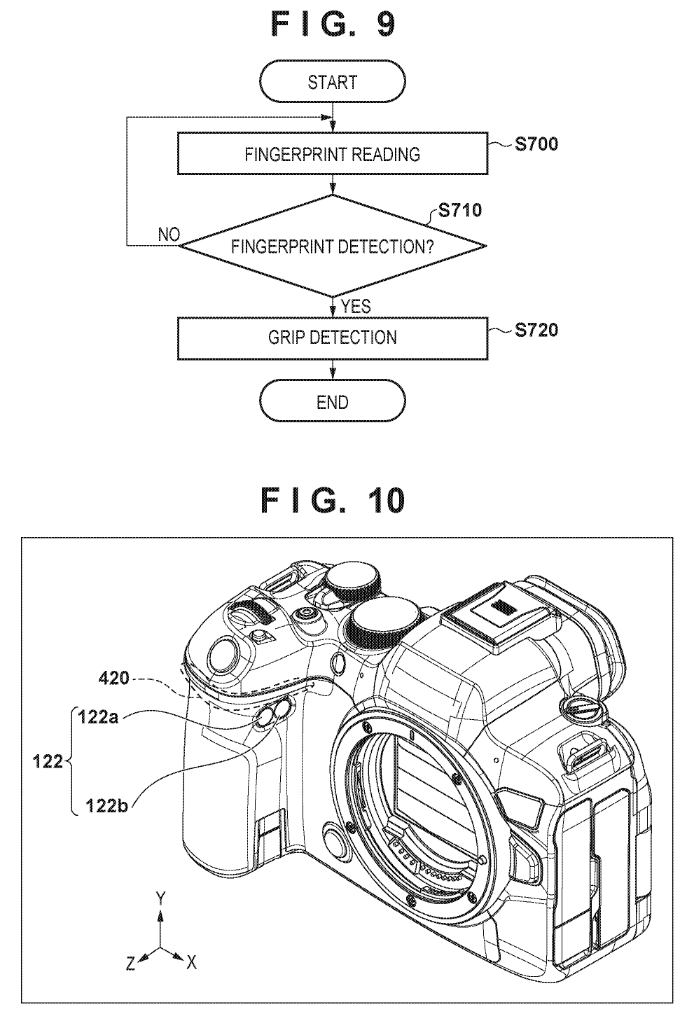

Next, grip detection using fingerprint detection in the present embodiment will be described with reference to FIG. 9. FIG. 9 is a flowchart of grip detection using the fingerprint authentication function. The operation of this flowchart is implemented by the system control unit 307 deploying, into the system memory 311, a control program stored in the nonvolatile memory 310 and executing it.

In step S700, the system control unit 307 reads the fingerprint by the front fingerprint detection unit 120 and the rear fingerprint detection unit 130, and transmits the read result to the system control unit 307.

In step S710, the system control unit 307 determines whether or not fingerprint information is included in the results of reading the fingerprint by the front fingerprint detection unit 120 and the rear fingerprint detection unit 130. In a case where the fingerprint information is included in the reading results of both the front fingerprint detection unit 120 and the rear fingerprint detection unit 130, the processing proceeds to step S720. In a case where the fingerprint information is not included in the reading result of at least one of the detection units, the process returns to step S700, and the reading of the fingerprint is repeated by the front fingerprint detection unit 120 and the rear fingerprint detection unit 130.

In step S720, the system control unit 307 determines that grip has been detected, and ends the processing of this flow.

Here, in the present embodiment, the grip detection is performed using the front fingerprint detection unit 120 and the rear fingerprint detection unit 130 constituted by a fingerprint sensor, but it may be that either of the front fingerprint detection unit 120 and the rear fingerprint detection unit 130 is not a fingerprint sensor. For example, any sensor, such as a pressure sensor or an optical sensor, may be used as long as it can detect that the finger of the user is in contact with the sensor.

As described above, using the front fingerprint detection unit 120 and the rear fingerprint detection unit 130, it is possible to detect that the user grips the digital camera 100. This enables fingerprint authentication after detecting that the user grips the digital camera 100, and therefore security is higher.

### Second Embodiment

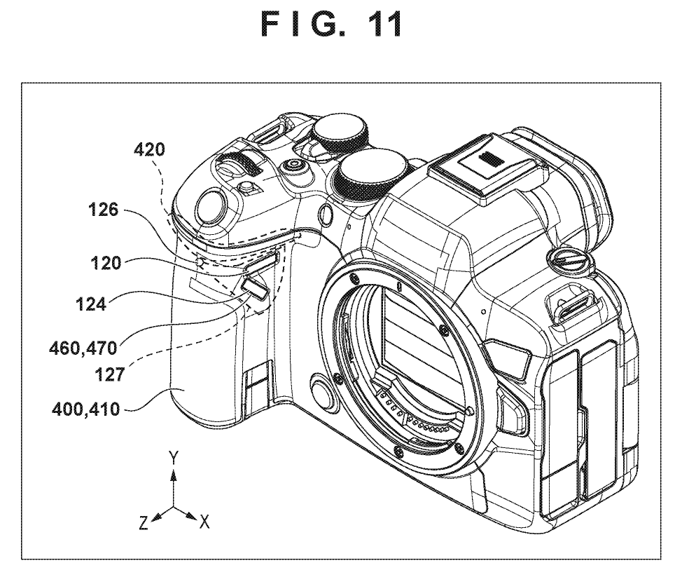

Hereinafter, the second embodiment of the present disclosure will be described with reference to FIG. 10. Note that parts having the same configurations as those of the first embodiment are denoted by the same reference numerals. In order to simplify the description, only parts having configurations different from those of the first embodiment will be described.

FIG. 10 is an external perspective view of a digital camera as an image capturing apparatus that is an example of an electronic apparatus in the second embodiment to which the present disclosure is applied.

A front fingerprint detection unit 122 of the second embodiment is disposed at a substantially parallel position separated from the front grip guide shape 420 by a predetermined distance. The front fingerprint detection unit 122 includes a first front fingerprint detection element 122a and a second front fingerprint detection element 122b disposed adjacent in a direction parallel to the front grip guide shape 420. The first front fingerprint detection element 122a and the second front fingerprint detection element 122b are electric elements constituted by fingerprint sensors that can acquire fingerprint images. In the present embodiment, the first front fingerprint detection element 122a and the second front fingerprint detection element 122b adopt electric elements having a circular outer shape, but may adopt electric elements having a substantially square outer shape, and can adopt fingerprint sensors having a generally distributed shape.

As described above, the front fingerprint detection unit 122 is configured such that the first front fingerprint detection element 122a and the second front fingerprint detection element 122b are disposed adjacent in the direction parallel to the front grip guide shape 420. This allows the user to touch the front fingerprint detection unit 122 in a gripped state even if the position of the fingertip beyond the first joint of the middle finger varies depending on the difference in finger length, when the user grips the digital camera 100. Therefore, the fingerprint detection accuracy is high. Specifically, since at least one of the first front fingerprint detection element 122a and the second front fingerprint detection element 122b can be touched, the fingerprint detection accuracy is good. Since a fingerprint sensor having a generally distributed shape can be adopted, it is possible to reduce the cost and increase the degree of freedom in design.

### Third Embodiment

Hereinafter, a digital camera as an image capturing apparatus that is an example of an electronic apparatus in the third embodiment to which the present disclosure is applied will be described with reference to FIG. 11. Note that parts having the same configurations as those of the first embodiment and the second embodiment are denoted by the same reference numerals. In order to simplify the description, only parts having configurations different from those of the first embodiment and the second embodiment will be described.

FIG. 11 is an external perspective view of a digital camera of the third embodiment.

A second front fingerprint detection unit 124 is a fingerprint sensor having the same configuration as that of the front fingerprint detection unit 120, and is disposed in the vicinity of the front fingerprint detection unit 120 and in a different orientation. A second front opening portion 460 and a second opening edge portion 470 are formed in a periphery of the second front fingerprint detection unit 124 of the front grip rubber 410. Since the same configuration as that of the front fingerprint detection unit 120 described above can be applied to the detailed configuration and the peripheral configuration of the second front fingerprint detection unit 124, description thereof will be omitted.

In the present embodiment, the front fingerprint detection unit 120 is disposed in a direction substantially parallel to the front grip guide shape 420, and the second front fingerprint detection unit 124 is disposed in such a direction that a distance from the front fingerprint detection unit 120 is short in a +Z direction and long in a -Z direction in the drawing.

Here, when the user grips the digital camera 100, the position of the fingertip beyond the first joint of the middle finger varies depending on the difference in size of the hand of the user, especially difference in length of the finger. This is because the engagement amount of the middle finger with respect to the front grip 400 varies depending on the difference in finger length. In some cases, the user engages the middle finger in an oblique direction of a -Y direction in the drawing, rather than engaging it along the front grip guide shape 420. That is, there is a case where the user engages a finger with a different orientation. According to the present embodiment, even a user who engages the fingers with different orientations can touch the second front fingerprint detection unit 124 in a state of gripping the digital camera 100. That is, the user can touch the front fingerprint detection unit 120 or the second front fingerprint detection unit 124 even if there is a difference in finger length or in the manner of finger engagement depending on the user, and therefore the fingerprint detection accuracy is good.

A grip fulcrum 126 is a point indicating a part where the vicinity of the second joint of the middle finger is placed, which is substantially common to a case where the middle finger is engaged along the front grip guide shape 420 described above and a case where the middle finger is engaged in an oblique direction of the -Y direction in the drawing. Even if there is a difference in the manner of finger engagement depending on the user, the user grips the digital camera 100 in a state where the middle finger is substantially in contact with the eaves shape of the front grip guide shape 420. At this time, the vicinity of the second joint of the middle finger is placed on the grip fulcrum 126, and the part beyond the second joint may be different depending on the user. A fingertip contact region 127 (broken line portion in the drawing) is a range indicating a region touched by the part beyond the second joint, and can be indicated by a partial circular shape centered on the grip fulcrum 126. By providing the fingertip contact region 127 with the front fingerprint detection unit 120 and the second front fingerprint detection unit 124, the user can touch the front fingerprint detection unit 120 or the second front fingerprint detection unit 124 even if there is a difference in finger length or in the manner of finger engagement depending on the user, and therefore the fingerprint detection accuracy is good.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. An electronic apparatus comprising:
a grip portion to be gripped by a hand of a user;
a convex shape portion that is formed above the grip portion and protrudes outward from the grip portion to support holding weight of the electronic apparatus with a hand; and
a first fingerprint detection device disposed at a position touched by a fingertip beyond a first joint of a finger in a case where the user grips the grip portion with the finger of the hand along the convex shape portion, the first fingerprint detection device having a fingerprint reading range in a longitudinal direction of the finger wider than a fingerprint reading range in a width direction of the finger.

2. The electronic apparatus according to claim 1, wherein the grip portion is a front grip portion disposed on a front side of the electronic apparatus, and the finger is a middle finger.

3. The electronic apparatus according to claim 1, wherein the grip portion is a rear grip portion disposed on a back side of the electronic apparatus, and the finger is a thumb.

4. The electronic apparatus according to claim 1, wherein the first fingerprint detection device includes a fingerprint detection sensor in which a dimension in the longitudinal direction of the finger is longer than a dimension in the width direction of the finger.

5. The electronic apparatus according to claim 1, wherein the first fingerprint detection device includes a plurality of fingerprint detection sensors adjacent in the longitudinal direction of the finger.

6. The electronic apparatus according to claim 1, further comprising an opening portion through which the first fingerprint detection device is inserted and an opening edge portion peripheral to the opening portion are formed in the grip portion, and the opening edge portion is formed so as to be substantially a same face as an appearance face of the first fingerprint detection device.

7. The electronic apparatus according to claim 6, further comprising an opening locking portion formed in a convex shape having a height higher than a surface of the grip portion is formed in a part of the opening edge portion.

8. The electronic apparatus according to claim 1, further comprising a push button disposed at a position close to an extension line in a longitudinal direction of the first fingerprint detection device in a vicinity of the first fingerprint detection device of the grip portion.

9. The electronic apparatus according to claim 1, wherein the first fingerprint detection device further includes a grip detection circuit that includes a first sensor disposed on a front face of the electronic apparatus and a second sensor disposed on a rear face of the electronic apparatus, and the first fingerprint detection device determines whether or not a user is gripping the electronic apparatus based on a reading result of the first sensor and a reading result of the second sensor.

10. The electronic apparatus according to claim 9, wherein at least one of the first sensor or the second sensor is a pressure sensor.

11. The electronic apparatus according to claim 1, further comprising a second fingerprint detection device disposed in a vicinity of the first fingerprint detection device and in an orientation different from an orientation of the first fingerprint detection device.

12. The electronic apparatus according to claim 11, wherein the first fingerprint detection device and the second fingerprint detection device are disposed in a range having a partial circular shape centered on a grip fulcrum positioned at a predetermined position of the convex shape portion.

13. The electronic apparatus according to claim 11, wherein a first opening portion through which the fingerprint detection device is inserted, a second opening portion through which the second fingerprint detection device is inserted, a first opening edge portion peripheral to the first opening portion, and a second opening edge portion peripheral to the second opening portion are formed in the grip portion, and the first opening edge portion and the second opening edge portion are formed so as to be substantially a same face as appearance faces of the first fingerprint detection device and the second fingerprint detection device, respectively.
